(19) United States
(12) Patent Application Publication
(10) Pub. No.: US 2015/0333813 A1
(43) Pub. Date: Nov. 19, 2015

(54) Method and Apparatus for Adaptive Resource Allocation

(71) Applicants: Honglai LIU, Beijing (CN); Telefonaktiebolaget L M Ericsson (publ), Stockholm (SE)

(72) Inventors: Honglai Liu, Beijing (CN); Shuang ZHAO, Beijing (CN); Yanchao NIU, Beijing (CN)

(73) Assignee: Telefonaktiebolaget L M Ericsson (publ), Stockholm (SE)

(21) Appl. No.: 14/758,838

(22) PCT Filed: Jan. 6, 2013
(86) PCT No.: PCT/CN2013/070107

§ 371 Date: Jul. 1, 2015

(51) Int. Cl. H04B 7/06; H04B 7/04; H04W 72/12

(52) U.S. Cl. CPC H04B 7/0639; H04W 72/1247; H04B 7/0413

(57) ABSTRACT

The embodiments disclose a method for adaptive resource allocation by an AP in a radio communication network utilizing MIMO-BF. The method comprises: calculating the PMI correlations between a first UE being served by the AP and each of a plurality of candidate UEs to be allocated resources by using the latest PMIs reported by the respective UEs, wherein the PMI correlation is indicated by the phase difference between the first UE and a candidate UE, and the plurality of candidate UEs are within the coverage of the AP; prioritizing the plurality of candidate UEs to be allocated resources in accordance with the calculated PMI correlations; selecting one or more second UEs from the plurality of candidate UEs based on the priority of the plurality of candidate UEs; and allocating resources to the one or more second UEs so as to serve them subsequently.

### TECHNICAL FIELD

The present technology generally relates to radio communication, particularly to a method and apparatus for adaptive resource allocation in a radio communication network utilizing Multiple Input Multiple Output Beamforming, MIMO-BF.

### BACKGROUND

In the radio communication network like Time Division Long Term Evolution (TD-LTE) and Frequency Division Long Term Evolution (FD-LTE) network employing the MIMO-BF technique, when an Access Point (AP) attempts to serve a User Equipment (UE) within its coverage, it will perform a BF towards the UE for communication. Generally, the MIMO-BF is performed based on the Channel State Information (CSI) estimated through the previous frame, with an assumption that such CSI may reflect the current channel state. However, due to the directivity for the BF, the BF performed towards a new UE may cause the significant interference variation among the UEs around (including the new UE), thus resulting in significant state change in the individual channels. In this case, the current channel state can not be suitably represented by the previously estimated CSI.

For example, as illustrated in FIG. 1, the AP 100 is serving the UE 101, i.e. performing BF towards the UE 101. As known, due to the directivity of the BF, the BF may produce relatively high inference to the UE 111, and relatively low interference to the UE 121 and 103. Subsequently, the AP 100 may determine to serve the UE 103 next, including allocating frequency resources to the UE 103 and performing the BF towards the UE 103. Since there is a large angle difference between the direction of the BF towards the UE 103 and the direction of the BF towards the UE 101, the dramatic interference variation in the surroundings will be caused. For example, the interference in some UEs such as the UE 121 may rapidly increase, while the interference in other UEs such as the UE 111 may rapidly decrease. In this case, the channel state balance among the UEs is broken, naturally the CSI of the UE 103 is also greatly varied; and thereby the previously estimated CSI for the UE 103 can not represent its current channel state at all.

On the other hand, according to 3GPP TS 36.213, the CSI is estimated by three key parameters: Channel Quality Indication (CQI), Precoding Matrix Indication (PMI) and Rand Indication (RI). These information is reported from UEs periodically or aperiodically according to the high layer configuration. Because of periodic or aperiodic CQI/PMI/RI reporting, the CQI/PMI/RI could not be measured and reported immediately in current frame. Based on the current Modulation and Code Scheme (MCS), interference variation would cause high Bit Error Rate (BER) or Frame Error Rate (FER) in UE 103 and decrease the actual MCS level of UE 103. As a result, the efficiency of MIMO-BF is deteriorated.

The Outer-Loop-Link-Adaptation (OLLA) is known as a useful method to adjust MCS level based on Hybrid Automatic Requestor (HARQ) mechanism. However, this method could not solve the problems discussed above, because it is a smooth method that only can adjust MCS level at a limited level for each subframe based on ACK/NACK. It can not adjust MCS level correctly if large interference or Signal to Interference (SINR) variation occurs.

### SUMMARY

Therefore, it is a strong desire to solve at least one of the above mentioned problems.

According to an aspect of the embodiments, there is provided a method for adaptive resource allocation by an AP in a radio communication network utilizing MIMO-BF, comprising: calculating the Precoding Matrix Indication (PMI) correlations between a first UE being served by the AP and each of a plurality of candidate UEs waiting to be allocated resources by using the latest PMIs reported by the respective UEs, the PMI correlation is indicated by the phase difference between the first UE and a candidate UE, and the plurality of candidate UEs are within the coverage of the AP; prioritizing the plurality of candidate UEs waiting to be allocated resources in accordance with the calculated PMI correlations; selecting one or more second UEs from the plurality of candidate UEs based on the priority of the plurality of candidate UEs; and allocating resources to the one or more second UEs so as to serve them subsequently.

According to another aspect of the embodiments, there is provided an Access Point (AP) allocating resources adaptively in a radio communication network utilizing MIMO-BF. The AP comprises a first calculating unit, a prioritizing unit and an allocating unit. The first calculating unit is adapted to calculate the Precoding Matrix Indication, PMI, correlations between a first UE being served by the AP and each of a plurality of candidate UEs waiting to be allocated resources, by using the latest PMIs reported by the respective UEs. The PMI correlation is indicated by the phase difference between the first UE and a candidate UE, and the plurality of candidate UEs are within the coverage of the AP. The prioritizing unit is adapted to prioritize the plurality of candidate UEs to be allocated resources in accordance with the calculated PMI correlations. The allocating unit is adapted to select one or more second UEs from the plurality of candidate UEs based on the priority of the plurality of candidate UEs, and allocate resources to the one or more second UEs so as to serve them subsequently.

According to further aspect of the embodiments, there is provided a computer program product, which comprises the instructions for implementing the steps of the method as described above.

According to still further aspect of the embodiments, there is provided a recording medium which stores instructions for implementing the steps of the method as described above.

Through taking the PMI correlation into account to select a new UE(s) that will be served next and allocate resources to the UE(s), the UE towards which the BF results in the lower interference variation among the UEs around will be weighted more to be selected, thereby the interference variation incurred by the switching of the service object (i.e. UE) is mitigated. In addition, because of the minor interference variation, the UEs in the surroundings may not necessarily report its channel measurement information frequently; therefore the UE report payload is alleviated.

### BRIEF DESCRIPTION OF THE DRAWINGS

The technology will now be described, by way of example, based on embodiments with reference to the accompanying drawings, wherein:

FIG. 1 illustrates a schematic view of APs in the radio communication network suitable for implementing an embodiment;

FIG. 2 illustrates a flowchart of adaptive resource allocation in the radio communication network in accordance with an embodiment;

FIG. 3 illustrates a flowchart of adaptive resource allocation in the radio communication network in accordance with another embodiment;

FIG. 4 is the block diagram of the AP used to allocating resource in accordance with an embodiment; and

FIG. 5 is the block diagram of the AP used to allocating resource in accordance with another embodiment.

### DETAILED DESCRIPTION

Embodiments herein will be described more fully hereinafter with reference to the accompanying drawings, in which embodiments are shown. This embodiments herein may, however, be embodied in many different forms and should not be construed as limited to the embodiments set forth herein. The elements of the drawings are not necessarily to scale relative to each other. Like numbers refer to like elements throughout.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Also, use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Unless otherwise defined, all terms (including technical and scientific terms) used herein have the same meaning as commonly understood. It will be further understood that terms used herein should be interpreted as having a meaning that is consistent with their meaning in the context of this specification and the relevant art and will not be interpreted in an idealized or overly formal sense unless expressly so defined herein.

The present technology is described below with reference to block diagrams and/or flowchart illustrations of methods, apparatus (systems) and/or computer program products according to the present embodiments. It is understood that blocks of the block diagrams and/or flowchart illustrations, and combinations of blocks in the block diagrams and/or flowchart illustrations, may be implemented by computer program instructions. These computer program instructions may be provided to a processor, controller or controlling unit of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

Accordingly, the present technology may be embodied in hardware and/or in software (including firmware, resident software, micro-code, etc.). Furthermore, the present technology may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that may contain, store, communicate, propagate, or transport the program for use by or in connection with the instruction execution system, apparatus, or device.

Although specific terms in some specifications are used here, such as AP, it should be understand that the embodiments are not limited to those specific terms but may be applied to all similar entities, such as cell, sector, base station, femto base station, Core Network (CN), NodeB, eNodeB, etc. The embodiments herein are described in the context of the Long Term Evolution (LTE) system, however, it should be understood that the embodiments may also be adapted to other existing communication protocols/standards adapted to employing the MIMO-BF technique, such as Time Division Synchronous Code Division Multiple Access (TD-SCDMA), Wireless Fidelity (WiFi), Bluetooth, Universal Mobile Telecommunications System (UMTS), Worldwide Interoperability for Microwave Access (WiMAX), Code Division Multiple Access (CDMA), Wideband Code Division Multiple Access High Speed Packet Access (WCDMA-HSPA) etc, and communication protocols/standards developed in the future.

Embodiments herein will be described below with reference to the drawings.

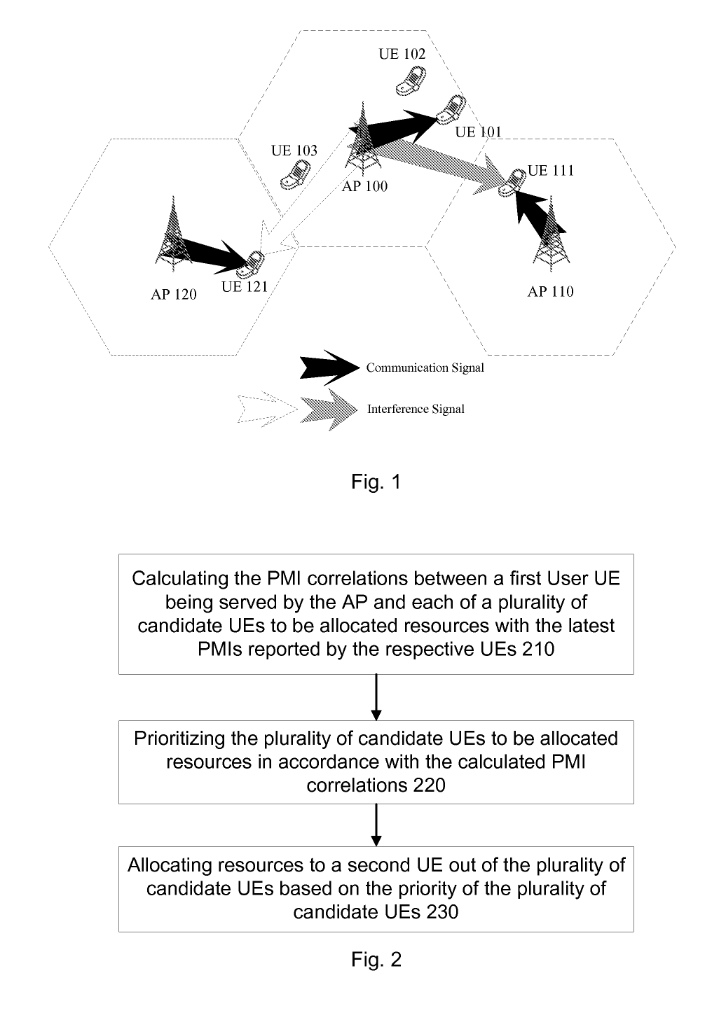

FIG. 1 illustrates a schematic view of APs in the radio communication network suitable for implementing an embodiment.

As shown in FIG. 1, there are three APs, AP 100, AP 110 and AP 120, in the radio communication network. The AP 100 covers the UEs 101-103, the AP 110 covers the UE 111 and the AP 120 covers the UE 121. In the radio communication network, MIMO-BF is used to implement the transmission between the APs and the UEs. As well known, MIMO precoding based on BF is a concept that allows the transmitter to send data to the desired receivers together with nulling out the direction to the undesired receivers. The MIMO hereof includes Single User MIMO (SU-MIMO) and Multi-User MIMO (MU-MIMO). Although the radio communication network consists of three APs, it will be appreciated that one or more APs may exist in the radio communication network, and each AP may serve one or more UEs within its coverage. The term “UE” used herein may indicate all forms of devices enabling the user to communicate via a radio communication network, such as smart phones, cellular phone, Personal Digital Assistant (PDA), and the like.

FIG. 2 illustrates a flowchart of adaptive resource allocation in the radio communication network utilizing MIMO-BF in accordance with an embodiment. Now the process of the embodiment will be described in detail with reference to the FIG. 2 and FIG. 1.

In step 210, the AP, e.g. AP 100, calculates the Precoding Matrix indication (PMI) correlations between a UE, e.g. UE 101, being served by the AP and each of a plurality of candidate UEs waiting to be allocated resources by using the latest PMIs reported by the respective UEs, wherein the plurality of candidate UEs are within the coverage of the AP.

Specifically, after the AP finishes providing communication service for one UE within its coverage, it may intend to serve another UE. It is likely that a plurality of active UEs have requested the AP for the resource, the AP need to decide which one(s) will be allocated resources for serving among the plurality of candidate UEs, which triggers the calculation of the PMI correlations. Alternatively, the PMI correlations may also be calculated periodically, as configured, to determine the resource allocation.

The PMI correlation is indicated by the phase difference between two UEs. In one embodiment, the PMI correlation is defined as equal to the phase difference in a simplest form without introducing additional signaling payload and computation complexity, which can be represented as

$$θ = 〈 {P}_{c} , {P}_{n} 〉 = arccos \frac{\vert {P}_{c} \cdot {P}_{n} \vert}{\vert {P}_{c} \vert \cdot \vert {P}_{n} \vert} , \qquad ( 1 )$$

Wherein θ is the PMI correlation, P_{c} is the PMI of the UE being served, Pₙ is the PMI of the candidate UE to be allocated resources. It should be understood the equation (1) does not suggest any limitation to the definition of the PMI correlation, it can also be embodied as any other suitable forms, such as equal to π minus the phase difference between the two UEs.

In operation, the AP may retrieve the latest PMIs reported by UEs from a database storing the PMI information of the individual UEs within its coverage. The database can be implemented as part of the AP, or separately. The database can either be used to uniquely store the PMI information or also store other data. Alternatively, the AP may also directly query the UEs of their latest PMIs.

For example, the candidate UEs requesting resources include UE 102 and UE 103, then the AP may retrieve the latest PMI of the UE 101, UE 102 and UE 103 from the database, and calculate the PMI correlation between UE 101 and UE 102, between UE 101 and UE 103 with the equation (1).

It should be appreciated that the above ways to calculate the PMI correlation are described by way of example, and any other suitable ways can be used in the embodiment.

In step 220, the AP, e.g. AP 100, may prioritize the plurality of candidate UEs to be allocated resources in accordance with the calculated PMI correlations in step 210.

Generally, the typical priority calculation can be accomplished by the proportional fair algorithm, which can be seen as:

$$P = \frac{{T}^{α}}{{R}^{β}} \qquad ( 2 )$$

Wherein, T denotes the data rate potentially achievable for the UE in the present frame, which is a kind of indication of the channel state. R is the historical average data rate of this UE, which can reflect the amount of the packets transmitted in history. α and β tune the “fairness” of the allocation and each is valued from 0 to 1.

Here, if α=0 and β=1, the UEs are treated equally in a round-robin fashion with no regard for resource consumption. If α=1 and β=0 then the UE with the best channel conditions will own the highest priority so as to be allocated resource and served. Using α=1 and β=1 will yield the proportional fair scheduling algorithm used in 3G networks as known.

The prioritization function in this embodiment may be obtained by adapting the equation (2) to take the PMI correlation into account. For example, the prioritization function can be defined as:

$${P}^{′} = \frac{{T}^{α ( Π - θ )}}{{R}^{β}} \qquad ( 3 )$$

Wherein θ is the PMI correlation. According to the equation (3), the priority of the candidate UE is inversely proportional to the corresponding PMI correlation. In other words, if a UE has a larger PMI correlation, performing BF towards such UE will cause a higher interference variation; thus the UE should be assigned a lower priority for resource allocation.

It should be appreciated that the above way to prioritize the candidate UEs is merely described by way of example, the priority can also be determined by other equations other than the proportional fair algorithm.

In step 230, the AP, e.g. AP 100, may select one or more UEs from the plurality of candidate UEs based on the priority of the plurality of candidate UEs; and allocate resources to the one or more second UEs so as to serve them subsequently. Specifically, the AP may select the one or more UEs with the same highest priority. Alternatively, the UEs with the top n (1≦n≦the number of the plurality of candidate UEs) highest priorities will be selected as the UEs allowed to be allocated resources. Here the resources to be allocated comprise the computational resource (such as resource used to performing BF) in the AP, the frequency resource for data transmission, the signaling resources, and the like.

Through taking the PMI correlation into account to select a new UE(s) that will be served next and allocate resources to the UE(s), the UE towards which the BF results in the lower interference variation among the UEs around will be weighted more to be selected, thereby the interference variation incurred by the switching of the service object (i.e. UE) is mitigated. In addition, because of the minor interference variation, the UEs in the surroundings may not necessarily report its channel measurement information frequently; therefore the UE report payload is alleviated.

Optionally, the AP may firstly filter all the UEs waiting for resource allocation to obtain the candidate UEs eligible to participate the PMI correlation calculation. Specifically, the AP may calculate the differences of Angle of Arrival (AoA) between the UE being served by the AP and each of all the UEs waiting for resource allocation, and then select the UEs with the difference of AoA less than a threshold as the candidate UEs. That is, only the UEs within the designated range around the UE being served are qualified to be served next. In this way, less UEs will be involved in the PMI correlation calculation and/or prioritization in the adaptive resource allocation processing, thereby the computational resource load is mitigated.

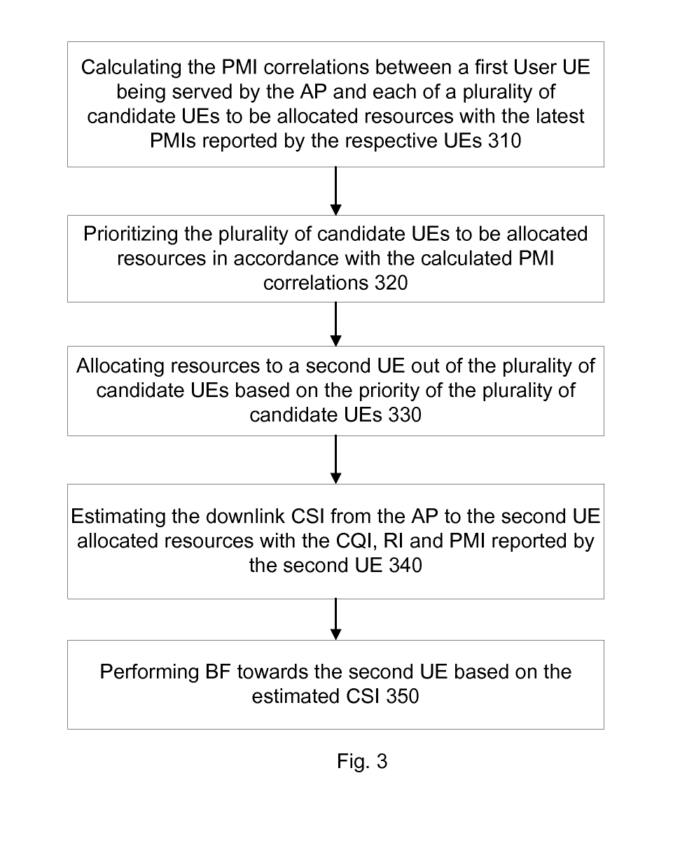

FIG. 3 illustrates a flowchart of adaptive resource allocation in the radio communication network in accordance with another embodiment.

In the embodiment, the steps 310, 320 and 330 in FIG. 3 work in the similar way to the steps 210, 220 and 230 in FIG. 2 as described above, which will not be repeated for purpose of conciseness.

After the resources have been allocated to the one or more UEs for serving in step 330, the AP may, for example, retrieve the Channel Quality Indication (CQI), Rank Indication (RI) and PMI reported by the one or more UEs from the database, and estimate the downlink Channel State Information (CSI) from the AP to each of the one or more UEs by using the corresponding CQI/RI/PMI (step 340). Subsequently, the AP may perform BF towards the one or more UEs based on the estimated CSIs (step 350). For example, the AP may calculate the BF weights with the estimated CSI. In particular, the BF weights may be represented as a matrix, which can be calculated with the CSI channel matrix by the matrix transformation. Since the CSI estimation and the performance of BF are known in the art, they will not be described in more detail here.

Due to the reduced interference variation attributed to the consideration of PMI correlation in switching the service object (i.e. UE), the previously estimated CSI may still appropriately represent the current channel state. As a result, performing the BF towards the new UE with the CSI estimated previously will not cause a high BER or FER and may maintain a reasonable MCS level in the new UE and the system performance is guaranteed.

Optionally, when the PMI correlations between the UE being served and each of the plurality of candidate UEs have been calculated, but before the execution of the resource allocation, if the AP receives the update PMIs from one or more of the candidate UEs, it may be configured to discard the calculated PMI correlations based on the out-of-date PMIs, and recalculate the PMI correlations with the update PMIs. Alternatively, it may be regulated that the PMI correlation recalculation will not be triggered unless all of the candidate UEs have reported their update PMIs to the AP during the time period. In this way, the update PMI correlation information may reflect the current channel state more accurately, thereby finding the suitable UE(s) to allocate resources and serve next. Preferably, the AP may also be configured to recalculate the PMI correlations only when it receives all of the update CQI, RI and PMI instead of the mere PMI. In this case, the CSI can be estimated more accurately by using the consistently updated CQI, RI and PMI.

Optionally, when a UE, e.g. UE 103, has been allocated resources and is to be served by the AP, e.g. AP 100, next, if the PMI correlation between the UE being served, e.g. UE 101, and the UE to be served, e.g. UE 103, exceeds the maximum range of BF by the AP, the AP may notify the neighboring APs, such as AP 110 and 120 of the frequency resources that have been allocated to the UE 103.

Specifically, as well known, there exists a limited BF range by the AP, that is, the AP can not perform BF in all directions, it only can perform the BF in a designated direction range. In this case, for example, if the PMI correlation, i.e. the phase difference, between the UE 101 within the BF range and the UE 103 is so large that the UE 103 is out of the BF range by the AP 100, the UE 103 will be served by the AP 100 through the means other than the BF, which may cause the potential interference with neighboring APs using the same frequency band. Thus, before serving the UE 103 at the allocated frequency resource, the AP 100 needs to send a Relative Narrowband TX Power, RNTP, bit map, which contains the information of the frequency resources allocated to the UE 103, to the AP 110 and 120 to inform that using such frequency band may cause the potential high interference. After receiving the RNTP bit map, the AP 110 and 120 may decrease the priority of using such frequency resources in response.

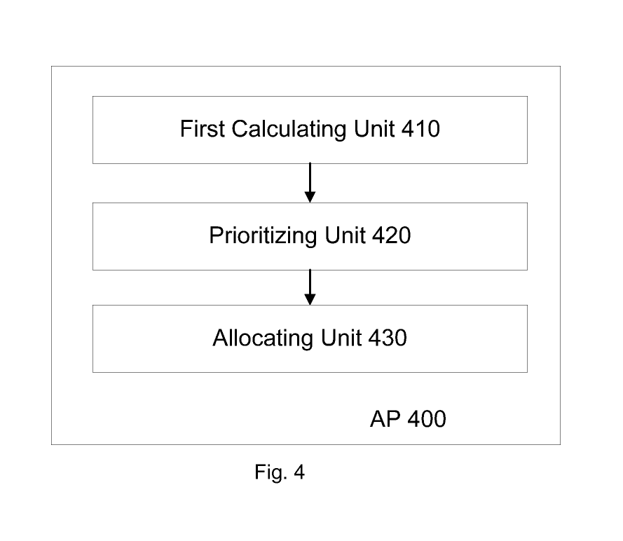

FIG. 4 is the block diagram of the AP used to allocating resource in accordance with an embodiment.

As illustrated in FIG. 4, the AP 400 comprises a first calculating unit 410, a prioritizing unit 420 and an allocating unit 430. The functions of the elements in the AP 400 will be described with reference the FIG. 4 and FIG. 1 now, wherein the AP 400 is taken as the AP 100 in FIG. 1.

Firstly, the first calculating unit 410 calculates the Precoding Matrix Indication (PMI) correlations between a UE, e.g. UE 101, being served by the AP 400 and each of a plurality of candidate UEs to be allocated resources by using the latest PMIs reported by the respective UEs, wherein the plurality of candidate UEs are within the coverage of the AP.

Specifically, after the AP finishes providing communication service for one UE within its coverage, it may intend to serve another UE. It is likely that a plurality of active UEs have requested the AP for the resource, the AP need to decide which one(s) will be allocated resources for serving among the plurality of candidate UEs, which triggers the calculation of the PMI correlations. Alternatively, the PMI correlations may also be calculated periodically, as configured, to determine the resource allocation.

The PMI correlation is indicated by the phase difference between two UEs. In one embodiment, the PMI correlation is defined as equal to the phase difference in a simplest form without introducing additional signaling payload and computation complexity, which can be represented as:

$$θ = 〈 {P}_{c} , {P}_{n} 〉 = arccos \frac{\vert {P}_{c} \cdot {P}_{n} \vert}{\vert {P}_{c} \vert \cdot \vert {P}_{n} \vert} , \qquad ( 1 )$$

Wherein θ is the PMI correlation, P_{c} is the PMI of the UE being served, Pₙ is the PMI of the candidate UE to be allocated resources. It should be understood the equation (1) does not suggest any limitation to the definition of the PMI correlation, it can also be embodied as any other suitable forms, such as equal to π minus the phase difference between the two UEs.

In operation, the first calculating unit 410 may retrieve the latest PMIs reported by UEs from a database storing the PMI information of the individual UEs within its coverage. The database can be implemented as part of the AP, or separately. The database can either be used to uniquely store the PMI information or also store other data. Alternatively, the first calculating unit 410 may directly query the UEs of their latest PMIs.

For example, the candidate UEs requesting resources include UE 102 and UE 103, then the first calculating unit 410 may retrieve the latest PMI of the UE 101, UE 102 and UE 103 from the database, and calculate the PMI correlation between UE 101 and UE 102, between UE 101 and UE 103 with the equation (1).

It should be appreciated that the above ways to calculate the PMI correlation are described by way of example, and any other suitable ways can be used in the embodiment.

Next, the prioritizing unit 420 may prioritize the plurality of candidate UEs to be allocated resources in accordance with the calculated PMI correlations by the first calculating unit 410.

Generally, the typical priority calculation can be accomplished by the proportional fair algorithm, which can be seen as:

$$P = \frac{{T}^{α}}{{R}^{β}} \qquad ( 2 )$$

Wherein, T denotes the data rate potentially achievable for the UE in the present frame, which is a kind of indication of the channel state. R is the historical average data rate of the UE, which can reflect the amount of the packets transmitted in history. α and β tune the “fairness” of the allocation and each is valued from 0 to 1.

Here, if α=0 and β=1, the UEs are treated equally in a round-robin fashion with no regard for resource consumption. If α=1 and β=0 then the UE with the best channel conditions will own the highest priority so as to be allocated resource and served. Using α=1 and β=1 will yield the proportional fair scheduling algorithm used in 3G networks as known.

The prioritization function in this embodiment may be obtained by adapting the equation (2) to take the PMI correlation into account. For example, the prioritization function can be defined as:

$${P}^{′} = \frac{{T}^{α ( Π - θ )}}{{R}^{β}} \qquad ( 3 )$$

Wherein θ is the PMI correlation. According to the equation (3), the priority of the candidate UE is inversely proportional to the corresponding PMI correlation. In other words, if a UE has a larger PMI correlation, performing BF towards such UE will cause a higher interference variation; thus the UE should be assigned a lower priority for resource allocation.

It should be appreciated that the above way to prioritize the candidate UEs is merely described by way of example, the priority can also be determined by other equations other than the proportional fair algorithm.

Then, the allocating unit 430 may select one or more UEs from the plurality of candidate UEs based on the priority of the plurality of candidate UEs; and allocate resources to the one or more UEs so as to serve them. Specifically, the allocating unit 430 may select the one or more UEs with the same highest priority. Alternatively, the UEs with the top n (1≦n≦the number of the plurality of candidate UEs) highest priorities will be selected as the UEs allowed to be allocated resources. Here the resources to be allocated comprise the computational resource (such as resource used to performing BF) in the AP, the frequency resource for data transmission, the signaling resources, and the like.

Through taking the PMI correlation into account to select a new UE that will be served next and allocate resources to the UE, the UE towards which the performance of BF results in the lower interference variation among the UEs around will be weighted more to be selected, thereby the interference variation incurred by the switching of the service object (i.e. UE) is mitigated. In addition, because of the minor interference variation, the UEs in the surroundings may not necessarily report its channel measurement information frequently; therefore the UE report payload is alleviated.

Optionally, the AP may firstly filter all the UEs waiting for resource allocation to obtain the candidate UEs eligible to participate the PMI correlation calculation. Specifically, the second calculating unit (not shown) may calculate the differences of Angle of Arrival (AoA) between the UE being served by the AP and each of all the UEs waiting for resource allocation, and then select the UEs with the difference of AoA less than a threshold as the candidate UEs. That is, only the UEs within the designated range around the UE being served are qualified to be served next. In this way, less UEs will be involved in the PMI correlation calculation and/or prioritization in the adaptive resource allocation processing, thereby the computational resource load is mitigated.

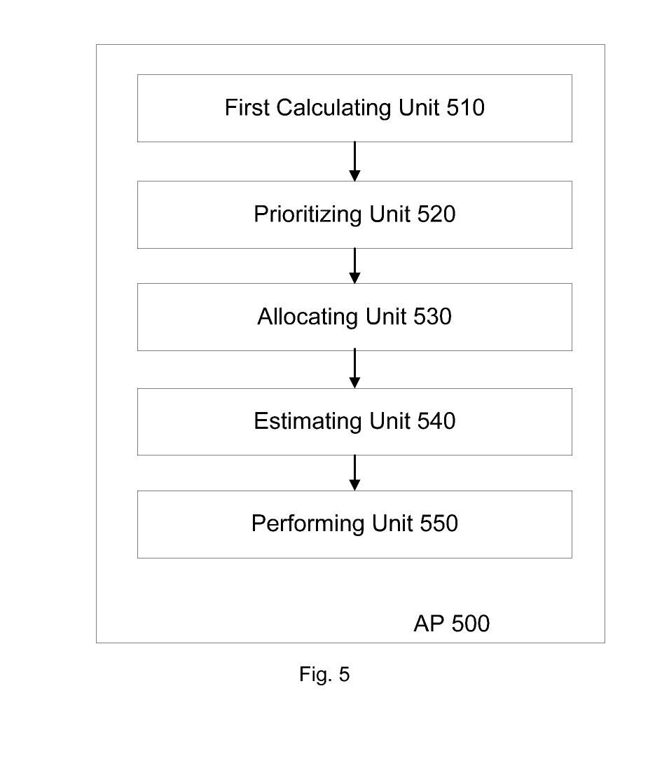

FIG. 5 is the block diagram of the AP used to allocating resource in accordance with another embodiment.

In the embodiment, the first calculating unit 510, the prioritizing unit 520 and the allocating unit 530 in FIG. 5 work in the similar way to the first calculating unit 410, the prioritizing unit 420 and the allocating unit 430 in FIG. 4 as described above, which will not be repeated for purpose of conciseness.

After the resources have been allocated to the one or more UEs for serving by the allocating unit 530, the estimating unit 540 may, for example, retrieve the Channel Quality Indication (CQI), Rank Indication (RI) and PMI reported by the one or more UEs from the database, and estimate the downlink Channel State Information (CSI) from the AP to each of the one or more UEs by using the corresponding CQI/RI/PMI. Subsequently, the performing unit 550 may perform BF towards the one or more UEs based on the estimated CSIs. For example, the performing unit 550 may calculate the BF weights with the estimated CSI. In particular, the BF weights may be represented as a matrix, which can be calculated with the CSI channel matrix by the matrix transformation. Since the CSI estimation and the performance of BF are known in the art, they will not be described in more detail here.

Due to the reduced interference variation attributed to the consideration of PMI correlation in switching the service object (i.e. UE), the previously estimated CSI may still appropriately represent the current channel state. As a result, performing the BF towards the new UE with the CSI estimated previously will not cause a high BER or FER and may maintain a reasonable MCS level in the new UE and the system performance is guaranteed.

Optionally, when the PMI correlations between the UE being served and each of the plurality of candidate UEs have been calculated, but before the execution of the resource allocation, if the AP receives the update PMIs from one or more of the candidate UEs, it may be configured to discard the calculated PMI correlations based on the out-of-date PMIs, and control the first calculating unit 510 to recalculate the PMI correlations with the update PMIs. Alternatively, it may be regulated that the PMI correlation recalculation will not be triggered unless all of the candidate UEs have reported their update PMIs to the AP during the time period. In this way, the update PMI correlation information may reflect the current channel state more accurately, thereby finding the suitable UE(s) to serve next. Preferably, the AP may also be configured to control the first calculating unit 510 to recalculate the PMI correlations only when it receives all of the update CQI, RI and PMI instead of the mere PMI. In this case, the CSI can be estimated more accurately by using the consistently updated CQI, RI and PMI.

Optionally, when a UE, e.g. UE 103, has been allocated resources and is to be served next, if the PMI correlation between the UE being served, e.g. UE 101, and the UE to be served, e.g. UE 103, exceeds the maximum range of BF by the AP, the notifying unit (not shown) may notify the neighboring APs, such as AP 110 and 120 of the frequency resources that have been allocated to the UE 103.

Specifically, as well known, there exists a limited BF range by the AP, that is, the AP can not perform BF in all directions, it only can perform the BF in a designated direction range. In this case, for example, if the PMI correlation, i.e. the phase difference, between the UE 101 within the BF range and the UE 103 is so large that the UE 103 is out of the BF range by the AP, The UE 103 will be served by the AP through the means other than the BF, which may cause the potential interference with neighboring APs using the same frequency band. Thus, before the UE 103 is served at the allocated frequency band, the notifying unit (not shown) needs to send a Relative Narrowband TX Power, RNTP, bit map, which contains the information of the frequency band allocated to the UE 103, to the AP 110 and 120 to inform that using such frequency resources may cause the potential high interference. After receiving the RNTP bit map, the AP 110 and 120 may decrease the priority of using such frequency resources in response.

While the embodiments have been illustrated and described herein, it will be understood by those skilled in the art that various changes and modifications may be made, and equivalents may be substituted for elements thereof without departing from the true scope of the present technology. In addition, many modifications may be made to adapt to a particular situation and the teaching herein without departing from its central scope. Therefore it is intended that the present embodiments not be limited to the particular embodiment disclosed as the best mode contemplated for carrying out the present technology, but that the present embodiments include all embodiments falling within the scope of the appended claims.

1. A method for adaptive resource allocation by an Access Point, AP, in a radio communication network utilizing Multiple Input Multiple Output Beamforming, MIMO-BF, comprising:
Calculating the Precoding Matrix Indication, PMI, correlations between a first User Equipment, UE, being served by the AP and each of a plurality of candidate UEs to be allocated resources with the latest PMIs reported by the respective UEs, wherein the PMI correlation is indicated by the phase difference between the first UE and a candidate UE, the plurality of candidate UEs are within the coverage of the AP;
Prioritizing the plurality of candidate UEs to be allocated resources in accordance with the calculated PMI correlations; and
Allocating resources to one or more second UEs from the plurality of candidate UEs based on the priority of the plurality of candidate UEs.

2. The method according to claim 1, wherein the PMI correlation θ is represented as:
$$θ = 〈 {P}_{c} , {P}_{n} 〉 = arccos \frac{\vert {P}_{c} \cdot {P}_{n} \vert}{\vert {P}_{c} \vert \cdot \vert {P}_{n} \vert} ,$$
Wherein P_{c} is the PMI of the first UE, Pₙ is the PMI of the candidate UE.

3. The method according to claim 1, wherein the priority of the candidate UE is inversely proportional to the corresponding PMI correlation, and the allocating step comprises the UE with the highest priority will be allocated resources.

4. The method according to claim 1, the method further comprises:
Calculating differences of Angle of Arrival, AoA, between the first UE being served by the AP and each of all UEs to be allocated resources, wherein the all UEs are within the coverage of the AP;
Selecting the UEs with the difference of AoA less than a threshold from the all UEs as the plurality of candidate UEs.

5. The method according to claim 1, after the allocating step, the method further comprises:
Estimating the downlink Channel State Information, CSI, from the AP to the second UE using the Channel Quality Indication, CQI, Rank Indication, RI, and PMI reported by the one or more second UEs;
Performing BF towards the second UE based on the estimated CSI.

6. The method according to claim 1, wherein if the update PMIs reported by the plurality of candidate UEs are received after the calculating step and before the allocating step, re-executing the calculating step.

7. The method according to claim 1, the method further comprises:
When the PMI correlation between the first UE and the second UE exceeds the maximum range of BF by the AP, notifying the neighbouring APs of the frequency resources that have been allocated to the second UE.

8. The method according to claim 1, wherein the prioritizing step comprises the plurality of candidate UEs are prioritized by using the proportional fair algorithm.

9. An Access Point, AP, allocating resources in a radio communication network utilizing Multiple Input Multiple Output Beamforming, MIMO-BF, comprising:
A first calculating unit adapted to calculate the Precoding Matrix Indication, PMI, correlations between a first User Equipment, UE, being served by the AP and each of a plurality of candidate UEs to be allocated resources with the latest PMIs reported by the respective UEs, wherein the PMI correlation is indicated by the phase difference between the first UE and a candidate UE, the plurality of candidate UEs are within the coverage of the AP;
A prioritizing unit adapted to prioritize the plurality of candidate UEs to be allocated resources in accordance with the calculated PMI correlations; and
An allocating unit adapted to allocate resources to one or more second UEs from the plurality of candidate UEs based on the priority of the plurality of candidate UEs.

10. The AP according to claim 9, wherein the PMI correlation θ is represented as:
$$θ = 〈 {P}_{c} , {P}_{n} 〉 = arccos \frac{\vert {P}_{c} \cdot {P}_{n} \vert}{\vert {P}_{c} \vert \cdot \vert {P}_{n} \vert} ,$$
Wherein P_{c} is the PMI of the first UE, Pₙ is the PMI of the candidate UE.

11. The AP according to claim 9, wherein
the priority of the candidate UE is inversely proportional to the corresponding PMI correlation, and
the allocating unit is adapted to allocate resources to the second UE with the highest priority.

12. The AP according to claim 9, further comprising:
A second calculating unit adapted to calculate differences of Angle of Arrival, AoA, between the first UE being served by the AP and each of all UEs to be allocated resources, wherein the all UEs are within the coverage of the AP;
A selecting unit adapted to select the UEs with the difference of AoA less than a threshold from the all UEs as the plurality of candidate UEs.

13. The AP according to claim 9, further comprising:
An estimating unit adapted to estimate the downlink Channel State Information, CSI, from the AP to the second UE using the Channel Quality Indication, CQI, Rank Indication, RI, and PMI reported by the second UE;
A performing unit adapted to perform BF towards the second UE based on the estimated CSI.

14. The AP according to claim 13, wherein the AP is adapted to, if the update PMIs reported by the plurality of candidate UEs are received after the execution of the first calculating unit and before the execution of the allocating unit, control the first calculating unit to re-execute to allocate resources.

15. The AP according to claim 9, further comprising:
A notifying unit adapted to, when the PMI correlation between the first UE and the second UE exceeds the maximum range of BF by the AP, notify the neighbouring APs of the frequency resources that have been allocated to the second UE.

16. The AP according to claim 9, wherein the prioritizing unit prioritizes the plurality of candidate UEs by using the proportional fair algorithm.

17. A computer program product, comprising instructions for implementing the steps of the method according to claim 1.

18. A recording medium which stores instructions for implementing the steps of the method according to claim 1.
